(19) United States
(12) Patent Application Publication
(10) Pub. No.: US 2008/0198723 A1
(43) Pub. Date: Aug. 21, 2008

(54) Method and Apparatus of Controlling Playback of an Optical Disc Program

(75) Inventors: Mo Li, Shanghai (CN); Yang Peng, Shanghai (CN)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/995,828

(22) PCT Filed: Jul. 11, 2006
(86) PCT No.: PCT/IB2006/052336

§ 371 Date: Jan. 16, 2008

(30) Foreign Application Priority Data
Jul. 22, 2005 (CN) 200510084966.9

(51) Int. Cl. G11B 7/00

(52) U.S. Cl. 369/100

(57) ABSTRACT

A method and apparatus for controlling playback of an optical disc program are provided. The method for controlling playback of an optical disc program comprises the steps of determining an execution condition of a markup sentence corresponding to the optical disc program, judging if the execution condition is a specific execution condition, generating a controlling message if the execution condition is the specific execution condition, wherein the controlling message is used for processing a markup file comprising the sentence based on the specific execution condition, so as to play back of the optical disc program. By the method and apparatus for controlling playback of an optical disc program provided by the present invention, a huge original markup file may be divided into a plurality of markup files. In addition, the preset playback effects will still be retained and at the same time, the occupation of the memory resource, the tedious work for re-editing the markup file and so on can be reduced.

### FIELD OF THE INVENTION

The present invention relates to the optical storage field, and more particularly relates to a method and apparatus for controlling playback of an optical disc program.

### BACKGROUND OF THE INVENTION

After the DVD (Digital Versatile Disc) optical disc standard, characterized by the high capacity, the flexible interface and so on, is proposed, the optical disc format of the new emerging HD-DVD (High Definition DVD) is making efforts to become the next generation optical disc standard.

Comparing with the DVD optical disc standard, the HD-DVD optical disc format not only mayprovide the storage media with higher speed and capacity, but also mayprovide more interactive functions with higher performance, so that the users maysmoothly participate in the playback process of the optical disc programs. The interactive function of the HD-DVD is implemented under the iHD-DVD specification. The iHD-DVD specification provides the enhanced navigation, the seamless connection to internet, the arrangement scheme for the interactive function frames (for example, the popup window and so on), the solution for carrying out the interactive functions between users, and so on.

The iHD-DVD specification employs the XML language (Extensible Markup Language) and the ECMAScript language (A standard script language established by European Computer Manufacturers Association) to edit markup file and script file. The XML markup file organizes and arranges the content of the optical disc programs. When the playback of the optical disc program is being performed, the XML file is loaded into the memory and is parsed as a DOM (Document Object Model) tree configuration file, and thus the corresponding content of the optical disc program or the chapters therein and so on become the nodes of the DOM tree. By the retrieval function provided by the DOM tree configuration file, the ECMAScript script file maycontrol the playback of the optical disc program conveniently.

When a relatively simple interactive function is implemented, the XML language will occupy fewer resources compared with other language (such as the Java language). However, when more complicated interactive function is implemented, the XML language is insufficient in the flexibility. To implement a relatively complicated interactive function, the XML file has to use a large amount of sentences and will expand to a huge file quickly, consequently, not only the parsing process will occupy a large amount of memory space and time, but also the testing and error-correction process for the file will become extremely difficult.

In the prior art, one of the solutions to solve the problem caused by the huge XML markup file is dividing it into several XML markup files (for example, according to the order, every 1000 sentences as a file and so on). When performing playback, the memory of the optical disc playback apparatus only processes one of the markup files each time. Such a scheme may reduce the occupation of the memory and time, but at the same time also cause XML files to lose their inherent relation from each other. Consequently, it is difficult for such a scheme to meet the requirement of playing back with rich effects.

For example, an XML file comprises the playback information for the program contents a and b. According to the preset playback effects, a and b will be played in synchronization under the triggering of the external event C. Because the XML file is relatively large, it is divided into three small markup files A, B and D, wherein, the playback information of the content a is in the file A, and the playback information of the content b is in the file B. When playing back the program, the optical disc playback apparatus only processes one of the A, B and D markup files separately each time.

Assuming that the current processing markup file is A, then after the external event C is received, the ECMAScript script file should retrieve the playback information for content a and content b. In the memory, the script file mayonly retrieve the playback information for content a, consequently, only the content a maybe played, the content b maynot be played, and the synchronization playback effects of a and b maynot be realized. If the current processing markup file is D, then the external event C will not be executed, consequently, both content a and content b maynot be played.

Another solution is to re-edit the XML file when being divided, so that each small markup file maybe executed relatively independently, and the relation with other markup files does not need to be considered. In view of the above example, the playback information of the content a and b is re-edited into the same small markup file. However, such a solution still possibly fails to process the external triggering event. In addition, if the designed playback effects are relatively complicated, then the re-editing work will be extremely tedious, moreover, sometimes the divided small markup files may be on the contrary more complicated and overstaffed, therefore, this is departed from the initial object of dividing the original XML file.

Accordingly, a method and apparatus for controlling playback of an optical disc program needs to be provided, so that not only the designed playback effects maybe guaranteed, but the occupation of memory and time and the editing cost maybe reduced.

### SUMMARY OF THE INVENTION

The object of the present invention is to provide a method and apparatus for controlling playback of an optical disc program to overcome the shortcomings of the prior arts.

According to an embodiment of the present invention, it is provided a method for controlling playback of an optical disc program, comprising the steps of determining an execution condition of a markup sentence corresponding to the optical disc program, judging if the execution condition is a specific execution condition, generating a controlling message if the execution condition is the specific execution condition, wherein the controlling message is used for processing a markup file comprising the sentence based on the specific execution condition, so as to play back of the optical disc program. The processing performed on the markup file comprises loading the markup file into the memory and executing. The controlling message may comprise description of the markup file that is executed based on the specific execution condition, description of a command to process the markup file, and the description of the executing sentence.

If the markup sentence is a sentence in an original markup file, the method further comprises the step of dividing the original markup file into a plurality of markup files, wherein the markup file that is loaded into the memory is one of the divided markup files.

According to an embodiment of the present invention, an apparatus for controlling playback of an optical disc program is provided. The apparatus comprises a determining means for determining an execution condition of a markup sentence corresponding to the optical disc program, a judging means for judging if the execution condition of the sentence is a specific execution condition, and a generating means for generating a controlling message if the execution condition is the specific execution condition, wherein the controlling message is used for processing a markup file comprising the sentence based on the specific execution condition, so as to play back of the optical disc program.

If the markup sentence is a sentence in an original markup file, the apparatus further comprises a dividing means for dividing the original markup file into a plurality of markup files, wherein the markup file that is loaded into the memory is one of the divided markup files.

By the method and apparatus for controlling playback of an optical disc program proposed by the present invention, a huge original markup file may be divided into a plurality of markup files, in addition, the preset playback effects will still be retained, at the same time, the occupation of the memory resource, the tedious work for re-editing the markup file and on the like may be reduced.

Other objects and effects of the present invention will become more apparent and easy to be understood from the following description and contents of the claims when taken in conjunction with the accompanying drawings, and more comprehensive understanding of the present invention will be achieved.

### BRIEF DESCRIPTION OF THE DRAWINGS

According to the embodiments, the present invention may be explained in more detail with reference to the accompanying drawings.

FIG. 1 is a flow chart functionally illustrating a method for controlling playback of an optical disc program according to an embodiment of the present invention;

FIG. 2 is a block diagram functionally illustrating an apparatus for controlling playback of an optical disc program according to an embodiment of the present invention; and

FIG. 3 is a schematic diagram functionally illustrating the DOM tree structure and controlling message file before and after the division of an original XML markup file according to an embodiment of the present invention.

Through all the drawings, the same reference number indicates same, similar or corresponding characteristics or functions.

### DETAILED DESCRIPTION OF THE INVENTION

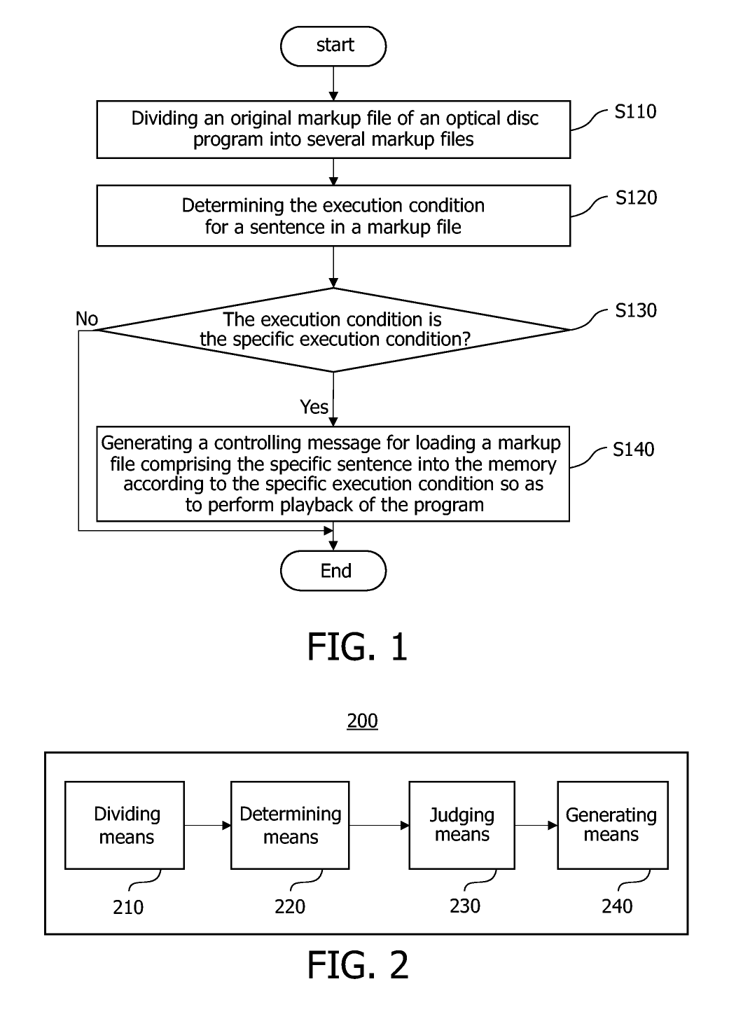

FIG. 1 is a flow chart functionally illustrating a method for controlling playback of an optical disc program according to an embodiment of the present invention. In the present embodiment, a huge original XML markup file and a JavaScript language (An embodied language for the ECMAScript script language standard) script file are used to control the playback arrangement of the optical disc program.

According to the present invention, firstly, the original XML file is divided into a plurality of small markup files (Step S110). The original XML file may be divided according to the order of the sentences, for example, each 500 sentences or 1000 sentences as a markup file and so on, or according to the relatively independent program chapters and so on. Each divided markup file is in form a complete file and has no relevancy with other markup files. However, according to the preset playback effects, the different markup files have associated playback relations, for example, the synchronizing playback and so on. During the playback of the optical disc, each markup file is loaded into the memory according to the order and is parsed into the DOM tree configuration file. In the prior art, after the execution of the last markup file is completed, the next markup file will be loaded into the memory and parsed into the DOM tree structure for executing, namely, the memory only process one of the markup files separately.

Secondly, the execution condition of a sentence in a markup file is determined (Step S120). Each sentence in the XML markup file is executed under the corresponding execution condition, wherein, the sentence may be executed according to the time order, or in synchronization with the playback of other sentences, further according to the external interactive event received from a user and so on.

Next, the execution condition is judged if it is a specific execution condition (Step S130). The specific execution condition indicates that the execution of the sentence is not limited to the execution triggered by the internal information within the markup file (such as the order of the sentences, or the time order and so on); but is related to the external information of the markup file. For example, the specific execution condition may be the execution condition possessed jointly by other markup sentences in other markup files, such as the time or event synchronization and so on, or may be conditioned on the execution of other sentences in other markup files, or the execution condition of the other sentences. The specific execution condition may also be the external triggering event, such as the interactive command of the user and so on.

For example, the execution condition of a sentence a in the markup file A is C, and that of a sentence b in the markup file B is also C, then the execution condition C is the specific execution condition. If the execution condition C is an external triggering event, such as an interactive command of the user, C is also the specific execution condition. If the execution condition C is the execution result of a sentence in another markup file, C also is also the specific execution condition.

If the execution condition is the specific execution condition, a controlling message is generated, so that according to the specific execution condition, a markup file comprising the sentence will be processed (for example, loaded into the memory for processing and so on), so as to play back of the optical disc program (Step S140). The controlling message establishes a relation among the specific execution condition, the markup sentence executed under the specific execution condition and the corresponding markup file. Namely, when the specific execution condition is satisfied, the corresponding markup file should be in the memory and the corresponding sentence should be executed. By using this playback relation, when the specific execution condition is satisfied, if a markup file comprising the sentence is not in the memory, then the markup file may be loaded into the memory by the controlling message.

All of the controlling messages corresponding to an optical disc program may compose a controlling message file. The controlling message file maybe stored on the optical disc as the JavaScript script file, and will be loaded into the memory of the optical disc playback apparatus together with the script file at the beginning of playback of the optical disc program so as to perform the initialization processing. By the controlling message file and the DOM tree parsed from the markup file, the script file may control the entire process of playback of the optical disc program and realize the preset playback effects.

According to the present invention, based on the requirements of the designed playback effects, besides the markup file processed according to the order, the markup files processed in the memory further may be the markup file loaded into the memory by the controlling message based on the specific execution condition. By using the present invention, the huge original markup file is divided into a plurality of markup files, so that the occupation of the memory resource, the tedious work for re-editing the markup file and on the like maybe reduced, in addition, the preset playback effects are still retained and not affected by the division of the original XML file.

FIG. 2 is a block diagram functionally illustrating an apparatus 200 for controlling playback of an optical disc program according to an embodiment of the present invention. The apparatus 200 may comprise a dividing means 210 for dividing the original XML file into a plurality of small markup files. The original XML file maybe divided according to the order of the sentences, for example, each 500 sentences or 1000 sentences as a markup file and so on, or according to the relatively independent program chapters and so on.

The apparatus 200 comprises a determining means 220 for determining the execution condition of a sentence in a markup file. Each sentence in the XML markup file is executed under the corresponding execution condition. Wherein, each sentence is executed according to the time order, or in synchronization with other sentences, or according to the causality order with other sentences, further according to the external interactive event received from a user and so on.

The apparatus 200 further comprises a judging means 230 for judging if the execution condition is a specific execution condition. The specific execution condition indicates that the execution of the sentence is not limited to the execution triggered by the internal information within the markup file (such as the order of the sentences, or the time order and so on); but related to the external information of the markup file. For example, the specific execution condition may be the execution condition possessed jointly by other markup sentences in other markup files, such as the time or event synchronization and so on, or may be conditioned on the execution of other sentences in other markup files, or the execution condition of the other sentences. The specific execution condition may also be the external triggering event, such as the interactive command of the user and so on.

The apparatus 200 further comprises a generating means 240. If the execution condition is the specific execution condition, based on the markup sentence and the markup file comprising the sentence, the generating means 240 generates a controlling message, so that a markup file comprising the sentence will be processed (for example, loaded into the memory) according to the specific execution condition, and thus the sentence is executed to implement playback of the optical disc program. The controlling message establishes a relation among the specific execution condition, the markup sentence executed under the specific execution condition and the corresponding markup file. Namely, when the specific execution condition is satisfied, the corresponding markup file should be loaded in the memory and the corresponding sentence should be executed. By using this playback relation, when the specific execution condition is satisfied, if a markup file comprising the sentence is not in the memory, the controlling message will load the markup file into the memory.

The generating means 240 may further be used to generate a controlling message file for all of the controlling messages corresponding to an optical disc program. The controlling message file may be stored on the optical disc as the JavaScript script file, and will be loaded into the memory of the optical disc playback apparatus at the beginning of playback of the optical disc program to control the entire process of playback of the optical disc program.

The apparatus for controlling playback of an optical disc program provided according to the present invention may be mounted in an optical disc playback apparatus, so as to form an optical disc playback apparatus provided by the present invention.

By using the apparatus for controlling playback of an optical disc program provided by the present invention, the huge original markup file is divided into a plurality of markup files, so that the occupation of the memory resource, the tedious work for re-editing the markup file and on the like maybe reduced, in addition, the preset playback effects are still retained and not affected by the division of the original XML file.

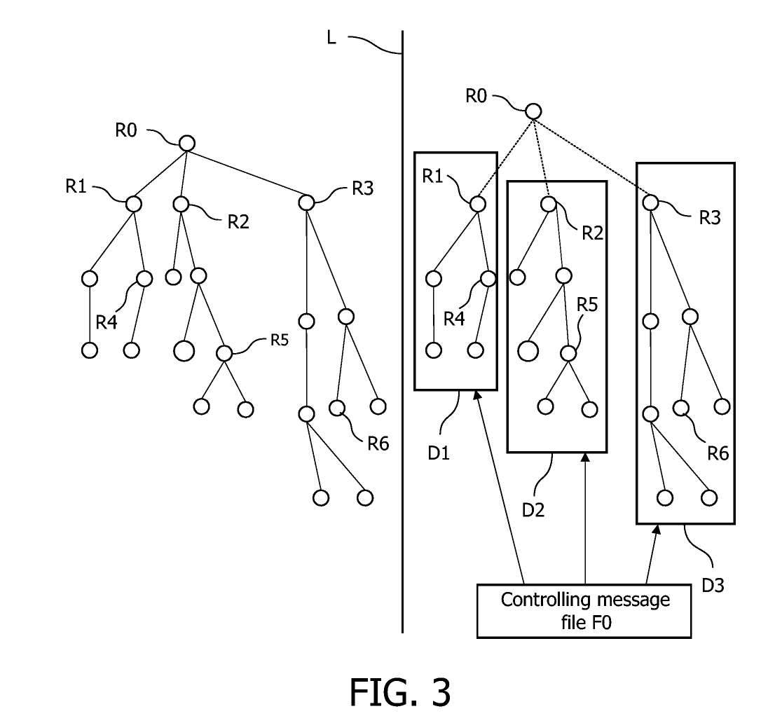

FIG. 3 is a schematic diagram functionally illustrating the DOM tree structure and controlling message file before and after the division of an original XML markup file according to an embodiment of the present invention. According to the prior art, during the playback of the optical disc, followed along with the JavaScript script file, the entire original XML file will be loaded into the memory and parsed into a DOM tree.

As shown is FIG. 3, the left side of the dashed line L is the DOM tree structure corresponding to the original XML markup file. Under the root node R0, there are three nodes R1, R2 and R3. Under the node R1, there are node R4 and other nodes. Under the node R2, there are node R5 and other nodes. Under the node R3, there are node R6 and the like. According to the preset playback effects, the contents for the nodes R4 and R5 will be played in synchronization. Moreover, the node R6 will be played based on the external interactive command.

The JavaScript script file may retrieve the nodes R4 and R5 through the node R0 in the DOM tree structure, so that the synchronization playback controlling of the nodes R4 and R5 maybe realized. If an interactive command event is received from a user, through the node R0 in the DOM tree, the script file will retrieve and execute the node R6.

Because the original XML file is relatively huge, and not every part of the file is in the execution state, for reducing the occupation of the memory, the original XML file maybe divided into three markup files, each of which is executed separately. Accordingly, the DOM tree is also divided into D1, D2 and D3 with the nodes R1, R2 and R3 as the root node respectively. The relation between the root node R0 and the nodes R1, R2 and R3 will be released, and thus the nodes R1, R2 and R3 become three new root nodes, which is shown in right side of the dashed line L in FIG. 3.

According to the prior art, because each time only one markup file will be loaded into the memory for processing, therefore, each time the memory also only process one DOM tree of the D1, D2 and D3. If the D1 is processed in the memory, when the script file plays the R4, it will discard the playback of R5 for failing to retrieve R5. When processing the D1 or D2, if the user command is received, the script file will discard the playback of R6 for failing to retrieve R6.

To solve this problem, according to the present invention, a controlling message file F0 is generated, which comprises one or more controlling messages. Each controlling message comprises the description for a specific execution condition, the description for the sentence executed under the specific execution condition and the description for the markup file comprising the sentence, in addition, the command information for loading the markup file into the memory if it is not in the memory and so on.

The controlling message file F0 will be loaded into the memory together with the script file of the optical disc program so as to perform initializing processing, so that the playback of the optical disc program play maybe started. The script file loads 3 markup files separately into the memory according to the order and executes each markup file so as to play the program, while receiving the external triggering event and on the like, whereas the F0 will load the markup file that needs to be executed but is not in the memory into the memory and execute the markup file, when the specific execution condition is satisfied. When the specific execution condition is satisfied, the number of the markup files processed by the memory may be two or more, in a few cases, may be all of the markup files.

The following is an example for a controlling message file F0 according to FIG. 3.

### F0.js:

```
Struct Sentences
{
  int sentence_number;
  string markup_file_name;
  Struct sentences *next_one;
}
Struct controlINFO
{
  ExecutionCondition ex_con;
  Sentences sl;
}
Sentences s1={10, “A.xml”, null};
controlINFO info1={ex_con1, s1};
Function sentence_active(ExecutionCondition ex_con)
{
  if (info1.ex_con1==ex_con)
    return s1;
  else
    return null;
}
Function memorycontrol (ExecutionCondition ex_con,
MarkerFile mk_files[3])
{
  Sentences sl=sentence_active(ex_con);
do
{
  for(int j=0;j<3;j++)
  {
    if ((mk_files[j].filename==sl.markup_file_name)
&&(mk_files[i].is_in_memory()
==false))
loadMarkerFile(mk_files[i]);
  }
  sl=*(sl.next_one);
  }
  while (sl.next_one!=null)
}
```

Wherein, the info1 is the controlling message, which comprises the specific execution condition ex_con1 and the description for the execution sentence executed by the triggering of the condition. The description is comprised in a sentence linked list s1, and the linked list s1 further comprises the description for the markup files comprising each sentence.

The parameter ex_con of the function memory control in the file F0 is the specific execution condition. If a specific execution condition ex_con1 is satisfied, namely the value of the ex_con is ex_con1, then the controlling message file F0 will retrieve the execution sentence linked list s1 corresponding to this condition, and determine if all the corresponding markup files are in the memory. If the markup file comprising the sentence that needs to be executed is not in the memory, then the controlling message will load the markup file into the memory by loadMarkerFile(mk_files[i]), so that the corresponding sentence maybe executed to perform playback of the optical disc.

By using the present invention, with the exception of executing a XML markup file according to the order, the markup file, which comprises the sentence that is executed under the specific execution condition, will also be loaded into the memory when the specific execution condition is satisfied, so that the playback effects maybe guaranteed. While the invention has been described with respect to the embodiment, it will be obvious to those skilled in the art that various substitutions, modifications and changes may be made in the above-described embodiment of the present invention. Thus all the substitutions, modifications and changes are within the spirit and scope of the invention as defined in the claims.

1. A method for controlling playback of an optical disc program, comprising the steps of:
determining an execution condition of a markup sentence corresponding to the optical disc program;
judging if the execution condition is a specific execution condition; and generating a controlling message if the execution condition is the specific execution condition, wherein the controlling message is used for processing a markup file comprising the sentence based on the specific execution condition, so as to play back of the optical disc program.

2. The method as claimed in claim 1, wherein the specific execution condition comprises a same execution condition for a plurality of markup sentences, which are contained in a plurality of markup files respectively.

3. The method as claimed in claim 1, wherein the specific execution condition comprises a corresponding execution condition between the markup sentence and other markup sentences, which are contained in a plurality of markup files with the markup sentence respectively.

4. The method as claimed in claim 1, wherein the specific execution condition comprises an external triggering event.

5. The method as claimed in claim 1, wherein, the controlling message comprises: description for the markup file comprising the sentence to be executed based on the specific execution condition, and description for a command to process the markup file.

6. The method as claimed in claim 5, wherein, the command to process the markup file comprises such a command to load the markup file into the memory and execute it.

7. The method as claimed in claim 1, if the markup sentence is a sentence in an original markup file, further comprising the step of dividing the original markup file into a plurality of markup files, wherein the markup file loaded into the memory is one of the divided markup files.

8. The method as claimed in claim 1, wherein the step of processing a markup file comprises loading the markup file into the memory and executing it.

9. An apparatus for controlling playback of an optical disc program, comprising:
a determining means for determining an execution condition of a markup sentence corresponding to the optical disc program;
a judging means for judging if the execution condition is a specific execution condition;
a generating means for generating a controlling message if the execution condition is the specific execution condition, wherein the controlling message is used for processing a markup file comprising the sentence based on the specific execution condition, so as to play back of the optical disc program.

10. The apparatus as claimed in claim 9, wherein the specific execution condition comprises a same execution condition for a plurality of markup sentences, which are contained in a plurality of markup files respectively.

11. The apparatus as claimed in claim 9, wherein, the specific execution condition comprises a corresponding execution condition for a plurality of markup sentences, which are contained in a plurality of markup files respectively.

12. The apparatus as claimed in claim 9, wherein, the specific execution condition comprises an external triggering event.

13. The apparatus as claimed in claim 9, wherein, the controlling message comprises: description for the markup file comprising the sentence to be executed based on the specific execution condition, and description for the command to process the markup file.

14. The apparatus as claimed in claim 13, wherein, the command to process the markup file comprises such a command to load the markup file into the memory and execute it.

15. The apparatus as claimed in claim 9, if the markup sentence is a sentence in an original markup file, further comprising a dividing apparatus for dividing the original markup file into a plurality of markup files, wherein the markup file loaded into the memory is one of the divided markup files.

16. The apparatus as claimed in claim 9, wherein the processing a markup file comprises loading the markup file into the memory and executing it.

17. An optical disc playback apparatus, comprising:
an optical disc reading apparatus for reading a program on an optical disc;
an apparatus for controlling playback of an optical disc program, comprising:
a determining means for determining an execution condition of a markup sentence corresponding to the optical disc program;
a judging means for judging if the execution condition is a specific execution condition;
a generating means for generating a controlling message if the execution condition is the specific execution condition, wherein the controlling message is used for processing a markup file comprising the sentence based on the specific execution condition, so as to play back of the optical disc program.

18. The playback apparatus as claimed in claim 17, wherein, the specific execution condition comprises a same execution condition for a plurality of markup sentences, which are contained in a plurality of markup files respectively.

19. The playback apparatus as claimed in claim 17, wherein, the specific execution condition comprises a corresponding execution condition for a plurality of markup sentences, which are contained in a plurality of markup files respectively.

20. The playback apparatus as claimed in claim 17, wherein, the specific execution condition comprises an external triggering event.

21. The playback apparatus as claimed in claim 17, wherein, the controlling message comprises: the description for the markup file comprising the sentence that is executed based on the specific execution condition, and the description for the command to process the markup file.
